(19) United States
(12) Patent Application Publication
(10) Pub. No.: US 2018/0178479 A1
(43) Pub. Date: Jun. 28, 2018

(54) COUNTER-DIE AND METHOD FOR CREASING PAPER, CARDBOARD OR CORRUGATED CARDBOARD

(71) Applicant: CITO-SYSTEM GMBH, SCHWAIG BEI NUERNBERG (DE)

(72) Inventor: OLIVER KELLERMANN, ALTDORF (DE)

(21) Appl. No.: 15/739,233

(22) PCT Filed: Dec. 20, 2016
(86) PCT No.: PCT/EP2016/001044

§ 371 Date: Dec. 22, 2017

(30) Foreign Application Priority Data
Jun. 24, 2015 (EP) 15001869.5

(51) Int. Cl. B31F 1/08; B26F 1/44

(52) U.S. Cl. CPC B31F 1/08; B26F 2001/4445; B26F 1/44

(57) ABSTRACT

A counter-die, in particular for creasing paper, cardboard or corrugated cardboard, has at least one groove channel which is formed, in relation to the groove channel cross section, between two groove channel walls which are spaced apart from one another and form the groove channel. The groove channel walls in each case form and/or have an upper side which forms a contact and/or bearing surface for the material to be cut and/or creased. The counter-die is formed at least in regions, preferably at least in a part region of a groove channel wall which is assigned to the groove channel, of an elastic material, in particular in order to provide an upper side of at least one groove channel wall of the at least one groove channel, which upper side can be displaced at least in regions and springs back elastically.

The invention relates to a counter-die, in particular for creasing paper, cardboard or corrugated cardboard, according to the preamble of claim 1.

Counter-dies, also referred to as creasing matrices, are generally known and relate to an auxiliary means which is used in punching or creasing, respectively, of paper, cardboard or corrugated cardboard (hereunder generally referred to as punched and/or creased product). Apart from the counter-dies that are formed by die strips (also referred to as finished channel grooves), so-called creasing matrixes or punch creasing plates are also part of the counter-dies.

In the context of the terminology used here, a die strip is a counter-die in which one die strip is required per groove channel or creasing channel, respectively. Thus a plurality of die strips are typically required per creasing or punching order respectively, in order for a mold to be constructed. The die strips per se are constructed such as is described, for example, in DE 197 15 800 C2, specifically having a carrier layer that carries two neighboring and mutually spaced-apart and often chamfered material strips, said carrier layer on the lower side thereof being provided with an adhesive layer and a cover layer that covers the adhesive layer. The two spaced-apart material strips therebetween define a groove or creased channel, respectively, in which a pilot strip that is referred to as a profiled assembly element is releasably mounted, said pilot strip in a manner known per se serving for being plug-fitted onto a crease line or the like in order for the counter-die to be positioned accurately on the punching plate. The upper side of the material strips that configures the contact and bearing face for the punched or creased product, respectively, for example a cardboard item, according to DE 197 15 800 C2 can at least in regions be provided with a so-called deflection filmstrip in order to avoid any unintentional or undesirable catching, respectively, of the cardboard material to be creased on the material strip of the creasing counter-die. The deflection filmstrip and the protective cover on the lower side here are extended in length such that both bear on one another in order to facilitate the cardboard material that is to be creased to slide thereon to in the manner of a ramp.

By contrast, a creasing matrix is understood to be a counter-die in which a plurality of creasing grooves are typically incorporated, for example milled. One creasing matrix per use is constructed, wherein a plurality of creasing matrices per creasing or punching order, respectively, are typically used in order for the mold to be constructed. The creasing matrices are then disposed or secured, respectively, on a base or carrier plate of the tool, typically on a so-called punching plate.

The punch-creasing plate is a punching plate as a counter-die which is preferably formed by a steel or metal plate, respectively, wherein the groove channels are already incorporated for example milled, into the punching plate. One punch-creasing plate in which all groove channels are incorporated is typically required per creasing or punching order, respectively.

The material strips of the die strips that configure the contact and bearing face for the material to be processed, like the creasing matrices and the punch-creasing plates, are produced from a dimensionally stable material. Counter-dies of this type have a specific operating life before they have to be exchanged or replaced, respectively, due to evidence of wear.

It is an object of the present invention to configure a counter-die, in particular for creasing paper, cardboard or corrugated cardboard, which has a high service life and operating life and/or has a high level of functionality. It is furthermore an object of the present invention to provide a suitable method management for creasing paper, cardboard, corrugated cardboard, or the like material.

This object is achieved by the features of the independent patent claims. Advantageous design embodiments are the subject matter of the dependent claims referring to said independent patent claims.

According to claim 1, a counter-die, in particular for creasing paper, cardboard or corrugated cardboard, is proposed, said counter-die having at least one groove channel which in relation to the groove-channel cross-section is configured between two mutually spaced-apart groove-channel walls that configure the groove channel, wherein the groove-channel walls configure and/or have in each case one upper side that configures a contact and/or bearing face for the punched and/or creased product to be processed. According to the invention, the counter-die, in particular for providing an elastically resilient upper side of at least one groove-channel wall of the at least one groove channel that is displaceable at least in regions in an impingement with pressure, is configured at least in regions, for example in a part-region of a groove-channel wall that is assigned to the groove channel, from an elastic material.

As tests by the inventors have surprisingly demonstrated, a longer service life and productive life can be achieved by a solution of this type according to the invention than in the case of conventional counter-dies which are produced from a hard material that does not display any elastic properties. As the tests by the inventors have demonstrated, the upper side at all times springs back to the initial position, on account of which it is achieved that the same conditions in a punching or creasing procedure, respectively, are always maintained for a very long time.

It is moreover achieved by the solution according to the invention that the rejection process of the processed punched and/or creased product is supported, and catching of the material to be processed can be reliably avoided in a simple and functionally safe manner on account thereof, such that an overall significantly improved production process results.

The terminology “for configuring or providing, respectively an elastically resilient upper side that is displaceable at least in regions” as used above and also hereunder is definitely not to be understood such that the upper side per se has to be at all times produced from an elastic material even when this may be the case in principle. This terminology is to be understood in an encompassing sense and means explicitly that at least some elastic region by way of the compression thereof the upper side, which optionally is also not made from an elastic material, is displaced, wherein the compressed region after the withdrawal of the impingement with pressure is again relaxed and on account thereof, that is to say by way of this relaxation of the elastic region, the upper side in a self-acting manner is displaced back to the initial or basic position, respectively, must be present on the counter-die. The elastic region of the counter-die can thus in principle be provided and configured at any suitable point or else on a plurality of points of the counter-die or of the parts of a counter-die that are relevant for the counter-die function, as long as the functionality of the displaceable upper side that springs back as stated above of at least a part-region of a groove channel wall of a groove channel is maintained. The counter-die herein is particularly preferably configured in such a manner that the counter-die that is configured at least in regions from an elastic material, that is to say from a substantially elastically compressible or elastically resilient material, respectively, in an impingement of the counter-die by pressure (that is to say in an impingement with a compressive force), in particular in an impingement with pressure of an upper side of the counter-die that configures the contact and/or bearing face for the punched and/or creased product to be processed, is at least partially compressible in such a manner that an upper side of at least one of the groove-channel walls, preferably of both groove-channel walls, of a groove channel (that is to say of the at least one or of at least one groove channel), proceeding from an initial position is displaced in a downward manner at least partially in the vertical axis and/or processing direction, wherein the upper side after the impingement with pressure, by virtue of the elastic material springing back to the uncompressed state in a self-acting manner, returns back to the initial position.

As has already been set forth above, the groove channel walls configure or have, respectively, in each case an upper side that configures a contact and/or bearing face for the punched and/or creased product to be processed. The upper sides of the groove channel walls that configure the contact and/or bearing faces for the punched and/or creased product herein are preferably aligned horizontally so as to configure as flat and planar a bearing face as possible for the punched and/or creased product to be processed. Alternatively or additionally, it is moreover preferably provided that the upper sides of two groove channel walls that delimit a groove channel when viewed in the direction of the vertical axis are at approximately the same height. The upper side that configures the contact and/or bearing face for the punched and/or creased product to be processed herein is thus preferably meant to be that surface or upper side, respectively, of the counter-die on which the punched and/or creased product bears directly during the punching and/or creasing procedure. That is to say a surface or upper side, respectively, without such additional elements such as, for example, a pilot strip of a die strip and/or a protective cover or the like, which are removed prior to the punching and/or creasing procedure and are thus not present during the punching and/or creasing procedure.

In principle, the entire counter-die or at least the component parts thereof that are relevant to the counter-die function can thus be produced from an elastic material. This is possible in the case of die strips having raised material strips as counter-dies, in which the material strips in this instance can be entirely produced from an elastic material, as well as possible and advantageous in the case of the more planar counter-dies such as, for example, creasing matrices and/or punch-creasing plates, in which the main bodies thereof can be entirely produced from an elastic material, for example. Alternatively thereto, it is provided according to a particularly preferred embodiment that the counter-die is configured from an elastic material only in regions, preferably at least in a part-region of a groove-channel wall that is assigned to the groove channel and comprises at least one elastic part-region that is formed from an elastic material, that is to say an elastically compressible or elastically resilient material, respectively. Said part-region when impinged with pressure (that is to say in an impingement with a compressive force) of the counter-die, in particular in an impingement with force of an upper side of the counter-die that configures the contact and/or bearing face for the punched and/or creased product that is to be processed is then at least partially compressible, specifically and preferably in such a manner that the upper side of at least one of the groove channel walls, preferably of both groove channel walls, of one groove channel (that is to say of the at least one or of at least one groove channel), proceeding from an initial position is displaced in a downward manner at least partially in the vertical axis and/or processing direction, wherein the upper side after the impingement with pressure, by virtue of the at least one elastic part-region springing back to the uncompressed state in a self-acting manner, returns back to the initial position.

A specific embodiment in which it is provided that at least one stable part-region which adjoins the at least one elastic part-region is configured by way of a material that is more dimensionally stable and/or harder in relation to the elastic part-region is particularly preferable. This imparts to the counter-die an overall higher stability. The stable part-region of the counter-die that adjoins the at least one elastic part-region herein is particularly preferably configured by way of a material that in an impingement with pressure in a specific compressive force range in which the at least one elastic part-region is compressible is dimensionally stable and non-compressible.

The term “dimensionally stable” is presently understood to mean that the region that is configured so as to be dimensionally stable, as opposed to the elastic material is not elastically or plastically deformed but retains its original geometry in an impingement with pressure, that is when a defined compressive force is applied.

The at least one elastic part-region, depending on the specific design embodiment of the respective counter-die, can in principle be disposed and configured on the counter-die in an arbitrary manner as long as it is ensured that the elasticity of the counter-die, or particularly preferably the functionality (displacement of the upper layer on the groove channel) as described above is maintained, respectively. In this context, a construction in which the at least one elastic part-region configures at least partially an external layer of the counter-die that preferably runs in the transverse direction and/or is horizontally aligned, and/or configures at least partially at least one intermediate layer of the counter-die that preferably runs in the transverse direction and/or is horizontally aligned is simple in terms of production technology and is producible in a functionally safe manner. Particularly preferable herein is a specific embodiment in which the upper side of at least one, preferably of each, of the groove channel walls of a groove channel that configures the contact and/or bearing face for the punched and/or creased product is at least in regions formed by an elastically resilient material and thus configures the elastic part-region.

According to a particularly preferred specific design embodiment it can be provided that the elastic part-region as an external layer that runs in the transverse direction and/or is horizontally aligned adjoins the stable part-region and configures at least partially an upper side and/or lower side in relation to the vertical axis and/or processing direction, preferably configures at least partially, or at least, the upper side that configures the contact and/or bearing face for the punched and/or creased product to be processed.

In the context of an intermediate layer it can be specifically provided, for example, that the elastic part-region that configures the at least one intermediate layer is adjoined on both sides, in relation to the vertical axis and/or processing direction, by in each case one layer of the stable part-region, or is adjoined on one side by a stable part-region and on the other side by a carrier and/or adhesive and/or cover layer, for example.

In order to save material, the elastic part-region, for example in the case of counter-dies with a large area, can be configured in at least one part-region that is directly adjacent to the groove channel, preferably at least in one upper-side peripheral edge region that is directly adjacent to the groove channel of at least one groove channel wall, preferably of both groove channel walls, that configure(s) a groove channel.

In the context of an elastic part-region that, for example, is provided only in regions on the upper side of the counter-die, it can moreover be provided that said elastic part-region is embedded in an assigned recess of the counter-die, said recess being on the periphery and/or being in the manner of a step or pocket, respectively, and specifically preferably is embedded such that the upper side region of the counter-die that is formed by the elastically resilient material adjoins the adjacent wall regions so as to be substantially flush with the surface. The counter-die is thus configured by the elastically resilient material precisely in that region in which the stress on the groove channel wall is the highest in the creasing or punching process, respectively. However, it is also to be understood that, depending on the specific type of counter-die used, the entire or at least a large part of the upper side of the respective counter-die can of course be configured by an elastically resilient material.

In the context of elastic part-regions in both opposite groove channel walls that configure the groove channel it can moreover be preferably provided that the elastic part-regions of opposite groove channel walls are at the same height and/or are identically configured. This can likewise be readily carried out in terms of production technology.

According to a first specific and particularly preferred design embodiment of the counter-die according to the invention, the latter is formed by a die strip having at least one groove channel, wherein the at least one groove channel (there are also die strips which have more than one groove channel) is formed by two mutually spaced-apart, raised material strips which configure the groove channel walls, and wherein at least one material strip, preferably both material strips, that configure(s) the groove channel walls of a groove channel, in particular for providing an upper side of at least one material strip of the at least one groove channel, said upper side being elastically resilient and at least in regions displaceable, is/are at least in regions (that is to say entirely or only in regions), preferably at least in a part-region of a material strip that is assigned to the groove channel configured from an elastic material. These raised material strips preferably run so as to be mutually parallel. Furthermore, the material strips of the die strip can be applied as raised profiles to a carrier layer in a manner known per se, said carrier layer preferably on that side that faces away from the material strip being provided with an adhesive layer, in particular with a pressure-sensitive adhesive layer. This adhesive layer in turn is preferably provided with the protective cover that covers the adhesive layer and is releasable, preferably by tearing off.

In one further specific design embodiment, at least one, preferably both, material strips, that configure(s) the groove channel walls of a groove channel is/are configured in multiple layers, wherein the at least one material strip is only in regions configured from an elastic material and has at least one elastic part-region. The at least one elastic part-region herein preferably configures at least one elastic layer of the material strip that preferably runs in the transverse direction and/or is horizontally aligned, said elastic layer of the material strip being adjoined by a residual wall region of the material strip which configures a stable part-region and which in relation to the at least one elastic layer is configured from a more dimensionally stable and/or harder material, particularly preferably is configured by a material which in an impingement with pressure in a compressive force range in which the at least one elastic layer is compressed, is dimensionally stable and non-compressible. Layers of this type that are preferably aligned in a substantially horizontal manner can be easily configured and be integrated in the material strip without any great effort, for example in such a manner that the at least one elastic layer that configures the at least one elastic part-region and preferably runs in the transverse direction and/or is horizontally aligned is an elastic upper layer that at least in regions configures the upper side, and/or is at least one intermediate layer that at least in regions configures an intermediate tier, and/or is an elastic lower layer of the material strip that at least in regions configures the lower side.

The indication “running in the transverse direction and/or horizontally aligned” as used above and also hereunder refers at all times to the cross-section through a groove channel of a counter-die.

According to a particularly preferred embodiment that in terms of production technology is producible in a particularly simple manner and with high functional reliability, it is proposed that at least one of the material strips that configures the groove channel walls of a groove channel, preferably both the material strips that configure the groove channel walls of a groove channel is/are configured in multiple layers, preferably two layers, wherein the elastic layer is in this case specifically now formed by an elastic upper layer that at least in regions, preferably entirely configures the upper side and is adjoined in particular in a downward manner and thus away from the upper layer by at least one lower layer of the material strip that configures the stable part-region, said lower layer being configured by material which in relation to the elastic upper layer is more dimensionally stable and/or harder, in particular is configured by material that in an impingement with pressure in a defined compressive force range in which the elastic upper layer is compressible, is dimensionally stable and non-compressible.

As has already been set forth above, it can optionally be sufficient for only one of two material strips that delimit a groove channel to be configured, for example on the upper side thereof, at least in regions, preferably entirely, from an elastically resilient material; however, for particularly good results both material strips that delimit a groove channel, are preferably configured, for example on the upper side thereof, at least in regions, preferably entirely, from an elastically resilient material. Even while overall construction in two layers is preferable, there can optionally be applications or cases in which a construction in multiple layers is advantageous.

In principle, there is the possibility for the individual layers to be configured by dissimilar material compositions within a material strip, for example in such a manner that a single source material (for example a single plastics material) is used for the material strips, at least one additional material, for example fibrous material, then being incorporated in regions such that the dissimilar layer-regions or part-regions are configured in order for the dissimilar part-regions or layers to be configured. The term “layer” or “multiple layers” used here is thus to be understood explicitly in a comprehensive sense and is to comprise all possible embodiments by way of which dissimilar part-regions in the aforementioned sense can be configured in conjunction with a material strip. Furthermore, a construction that in terms of production or manufacturing technology is particularly simple and in which the individual part-regions or layers, respectively, of the material strip are configured by separate layers which are fixedly interconnected can also be provided. It could be provided herein, for example, that an elastic upper layer is fixedly connected to the at least one stable lower layer lying directly below the former. The fixed connection can in principle be produced in many ways but is preferably produced in a materially integral manner for example by adhesive bonding, laminating, extruding, etc.

The at least one elastic part-region or the at least one elastic layer, respectively, when viewed in the longitudinal extent direction of the die strip, preferably extends across the entire length of the material or die strip, respectively. However, for certain applications it could optionally also be sufficient for the at least one elastic part-region or the at least one elastic layer, respectively, when viewed in the longitudinal extent direction of the die strip, to extend only partially or in portions across the material strip length. The individual elastic part-regions or portions of opposite material strips that configure the groove channel walls, respectively, herein can in principle also be mutually offset in the longitudinal direction.

The at least one elastic layer of a material strip preferably has a layer thickness of 0.01 to 1.9 mm, preferably of 0.05 to 0.30 mm (this in the case of a plurality of elastic layers being an overall layer thickness of all elastic layers). The material strip per se preferably has an overall layer thickness of 0.1 to 2.0 mm, preferably of 0.3 to 1.7 mm. The aforementioned advantages according to the invention have resulted in a particularly outstanding manner by way of layer thicknesses of this type. All preceding indications relate in each case only to the material strip per se, that is without any inclusion of any potential adhesive layers, carrier layers, or cover layers of a die strip. It is furthermore understood that the ranges above have to be mutually complementary in a technically expedient manner and that the elastic layer in the case of a required overall layer thickness of, for example, 0.5 mm of course cannot have a value of, for example, 0.51 mm or more.

According to a specific design embodiment that is an alternative to the die strip, the counter-die can also be a creasing matrix or a punch-creasing plate having at least one groove channel that is machined in a depressed manner into the surface of a matrix main body or of a punching plate as a punch-creasing plate main body, such that the groove channel walls that delimit the at least one groove channel are configured by the matrix main body or by the punch-creasing plate main body. The matrix main body or the punch-creasing plate main body, in particular for providing an elastically resilient upper side that is displaceable at least in regions of at least one groove channel wall of the at least one groove channel is at least in regions, preferably at least in a part-region of a groove channel wall that is assigned to the groove channel configured from an elastic material. This means specifically that the matrix main body or the punch-creasing plate main body in an impingement with pressure (that is to say in an impingement with a compressive force), in particular in an impingement with pressure of an upper side that configures the contact and/or bearing face for the punched and/or creased product to be processed, is at least partially compressible in such a manner that an upper side of at least one of the groove channel walls, preferably of both groove channel walls, of a groove channel (that is to say of the at least one or of at least one groove channel), proceeding from an initial position, is displaced in a downward manner at least partially in the vertical axis and/or processing direction, wherein the upper side after the impingement with pressure, by virtue of the elastic material springing back to the uncompressed state in a self-acting manner, returns back to the initial position.

The matrix main body or the punch-creasing plate main body are preferably configured from an elastic material only in regions such that at least one elastic part-region that is configured by the elastic material is provided. This at least one elastic part-region herein according to a particularly preferred specific design embodiment can at least partially be formed by at least one elastic layer of the matrix main body or of the punch-creasing plate main body that preferably runs in the transverse direction and/or is horizontally aligned, said elastic layer being adjoined by a residual wall region of the matrix main body or of the punch-creasing plate main body that configures a stable part-region which in relation to the at least one elastic layer is configured from a more dimensionally stable and/or harder material, in particular is configured by a material which in a defined impingement with pressure in a defined compressive force range in which the at least one elastic layer is compressed, is dimensionally stable and non-compressible. These layers which are preferably aligned in a horizontal manner can be readily configured and be integrated in the respective main body without a high effort, for example in such a manner that the at least one elastic layer that configures the at least one elastic part-region and preferably runs in the transverse direction and/or is horizontally aligned is formed by an elastic upper layer that at least in regions configures the upper side and/or by at least one elastic intermediate layer that at least in regions configures an intermediate tier, and/or by an elastic lower layer of the matrix main body or of the punch-creasing plate main body that at least in regions configures the lower side.

In principle, there is also here the possibility for the individual layers to be configured by dissimilar material compositions within the main body, for example in such a manner that a single source material (for example a single plastics material) is used for the layers, at least one additional material, for example fibrous material, then being incorporated in regions such that the dissimilar layer-regions or part-regions are configured in order for the dissimilar part-regions or layers to be configured. The term “layer” or “multiple layers” used here is thus to be understood explicitly in a comprehensive sense and is to comprise all possible embodiments by way of which dissimilar part-regions in the aforementioned sense can be configured in conjunction with a matrix main body or a punch-creasing main body. Furthermore, a construction that in terms of production or manufacturing technology is particularly simple and in which the individual part-regions or layers, respectively, of the matrix main body or of the punch-creasing main body are configured by separate layers which are fixedly interconnected can also be provided. It could be provided herein, for example, that an elastic upper layer is fixedly connected to the at least one stable lower layer lying directly below the former. The fixed connection can in principle be produced in many ways but is preferably produced in a materially integral manner for example by adhesive bonding, laminating, extruding, etc.

According to a particularly preferred design embodiment it thus applies to the counter-die according to the invention generally, that is to say independently of whether said counter-die is a die strip, a creasing matrix, a punch-creasing plate, for example, or the like, that the individual part-regions or layers, respectively, of the counter-die can be configured, for example, by dissimilar material compositions within a single element, or that the individual layers of the counter-die can be configured, for example, by separate layers that are fixedly interconnected.

The at least one elastic layer of the matrix main body or of the punch-creasing plate main body can particularly advantageously have a layer thickness (this in the case of a plurality of elastic layers being an overall layer thickness of all elastic layers) of 0.01 to 1.90 mm, preferably of 0.05 to 0.30 mm. The matrix main body or the punch-creasing plate main body furthermore preferably has an overall layer thickness of 0.1 to 2.0 mm, preferably of 0.3 to 1.7 mm. The aforementioned advantages according to the invention have resulted in a particularly outstanding manner by way of layer thicknesses of this type. It is furthermore understood that the ranges above have to be mutually complementary in a technically expedient manner and that the elastic layer in the case of a required overall layer thickness of, for example, 0.5 mm of course cannot have a value of, for example, 0.51 mm or more.

According to a particularly preferred design embodiment it thus applies to the counter-die according to the invention generally, that is to say independently of whether said counter-die is a die strip, a creasing matrix, a punch-creasing plate, for example, or the like, that the at least one elastic layer of the counter-die can have a layer thickness of, for example, 0.01 to 1.9 mm, preferably of 0.05 to 0.30 mm, and/or that the counter-die can have an overall layer thickness of, for example, 0.1 to 2.0 mm, preferably of 0.3 mm to 1.7 mm.

In the case of the counter-die not being entirely produced from an elastic material, the material that in relation to the at least one elastic part-region is more dimensionally stable and/or harder is preferably formed by a plastics material and/or by metal and/or by fiber board. The stable part-region is particularly preferably formed by, for example, a thermosetting or thermoplastic plastics material, for example polyester or polypropylene, said plastics material optionally being fiber-reinforced. A thermosetting or thermoplastic plastics material and an optionally fiber-reinforced plastics material of this type can optionally also be a plastics material that is suitable for extrusion such that the layers can be fixedly interconnected for example by multiple extrusion, in particular by co-extrusion. This applies in equal measure to die strips, creasing matrixes, and punch-creasing plates.

The creasing matrix, or the main body thereof, respectively, as previously can of course also be produced from a hard paper, preferably from a hard paper which as a fiber-composite material is produced from paper and a resin, for example a phenol-formaldehyde resin (phenoplast), for example from Pertinax®.

The punch-creasing plate, or the main body thereof, respectively, as previously can of course also be formed by a steel or metal plate, respectively, in which the groove channels are incorporated, for example milled.

The at least one stable part-region which in relation to the elastic part-region is configured from a more dimensionally stable and/or harder material preferably has an elasticity modulus of 600 to 250,000 MPa, preferably of 1000 to 220,000 MPa, most preferably of 2000 to 210,000 MPa. In the case of a die strip, the elasticity modulus of the stable part-region is preferably 600 to 100,000 MPa, particularly preferably 700 to 40,000 MPa. In the case of a creasing matrix, the elasticity modulus of the stable part-region is preferably 600 to 100,000 MPa, particularly preferably 1000 to 50,000 MPa. And in the case of a punch-creasing plate, the elasticity modulus of the stable part-region is preferably 1000 to 240,000 MPa, particularly preferably 2000 to 220,000 MPa.

The elastic material, or the at least one elastic part-region, respectively, is preferably formed by an elastomer, for example by at least one elastomeric layer that preferably runs in the transverse direction and/or is horizontally aligned, that is to say by a layer from an elastomer or of an elastomeric plastics material, respectively, or elastomeric material, respectively, on account of which a particularly reliable and functionally safe configuration of the elastic part-region is achieved. In particular polyurethane (PU) and particularly preferably TPU (thermoplastic polyurethane) are suitable elastomers.

Particularly advantageous practical results can moreover be achieved when the elastic material, preferably the at least one elastic part-region, most preferably the at least one elastic layer, has an elasticity modulus of 10 to 500 MPa, preferably of 20 to 400 MPa, most preferably of 20 to 250 MPa.

The elastic material herein, in particular in the context of a creasing matrix or a punch-creasing plate as the counter-die, can be applied and/or incorporated either prior to or after the incorporation of the groove channels into the matrix main body or the punch-creasing plate main body, for example be applied as an elastomeric layer. In particular in the case of hard, rigid main body basic materials in conjunction with elastomeric intermediate layers it is then often necessary for the latter as an elastomeric intermediate layer to extend completely or almost completely, respectively, across the entire area of extent of the main body in order for the displacement of the upper side to be enabled.

The advantages that are derived by way of the method management according to the invention in an identical manner correspond to those of the counter-die according to the invention. To this extent, reference is made to the explanations above.

The invention will be explained hereunder by means of a plurality of exemplary embodiments.

In the figures:

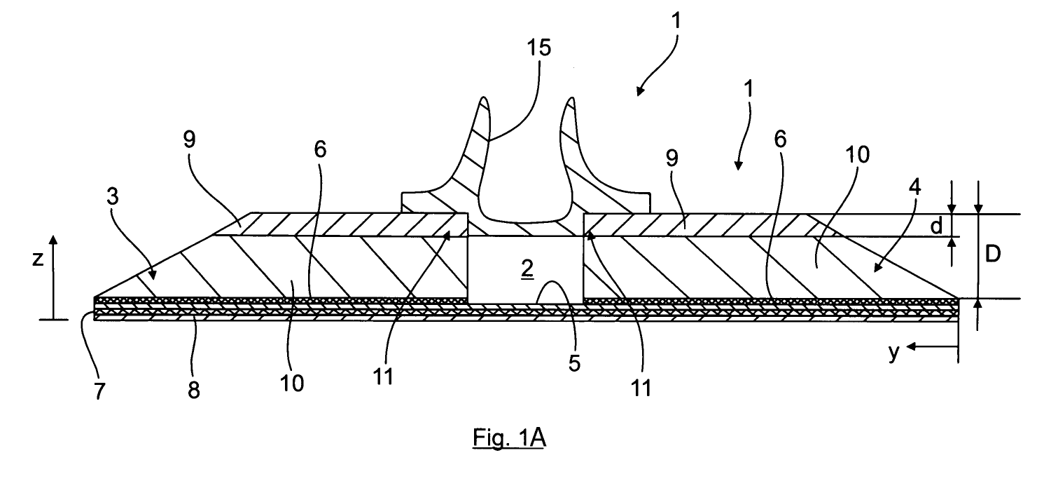

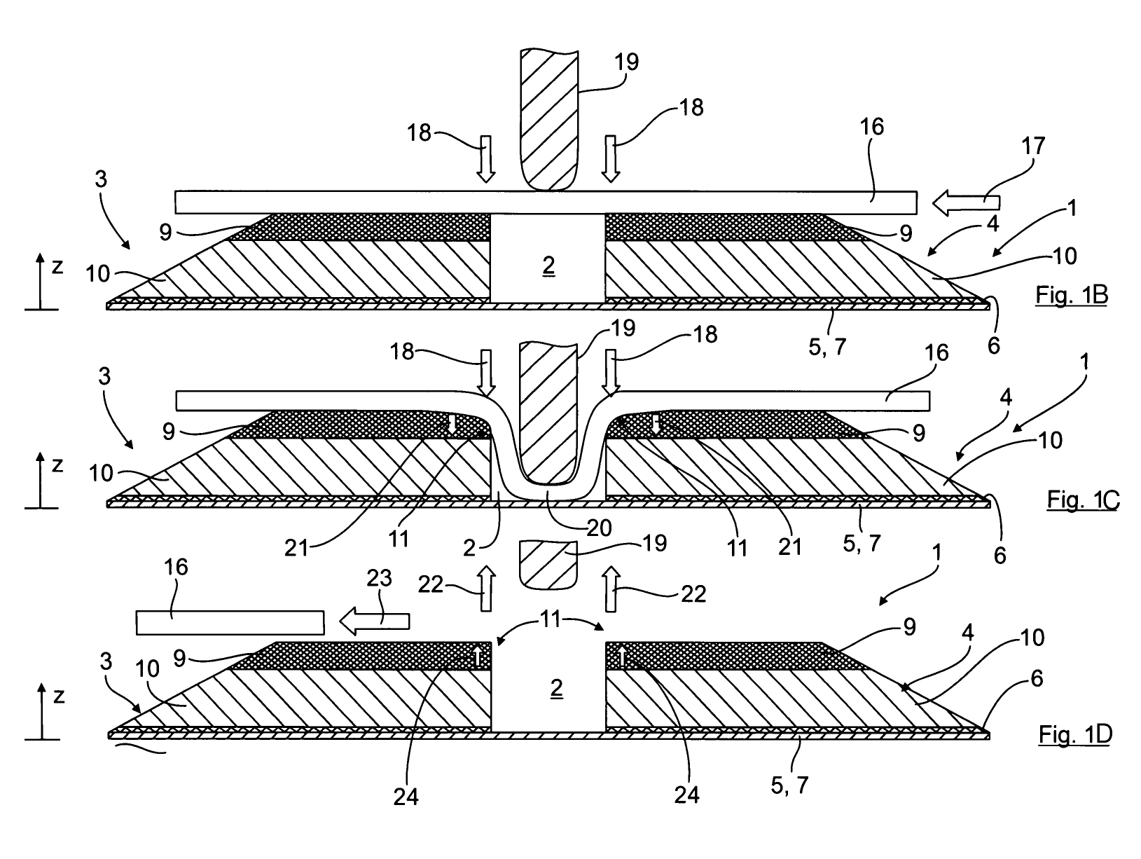

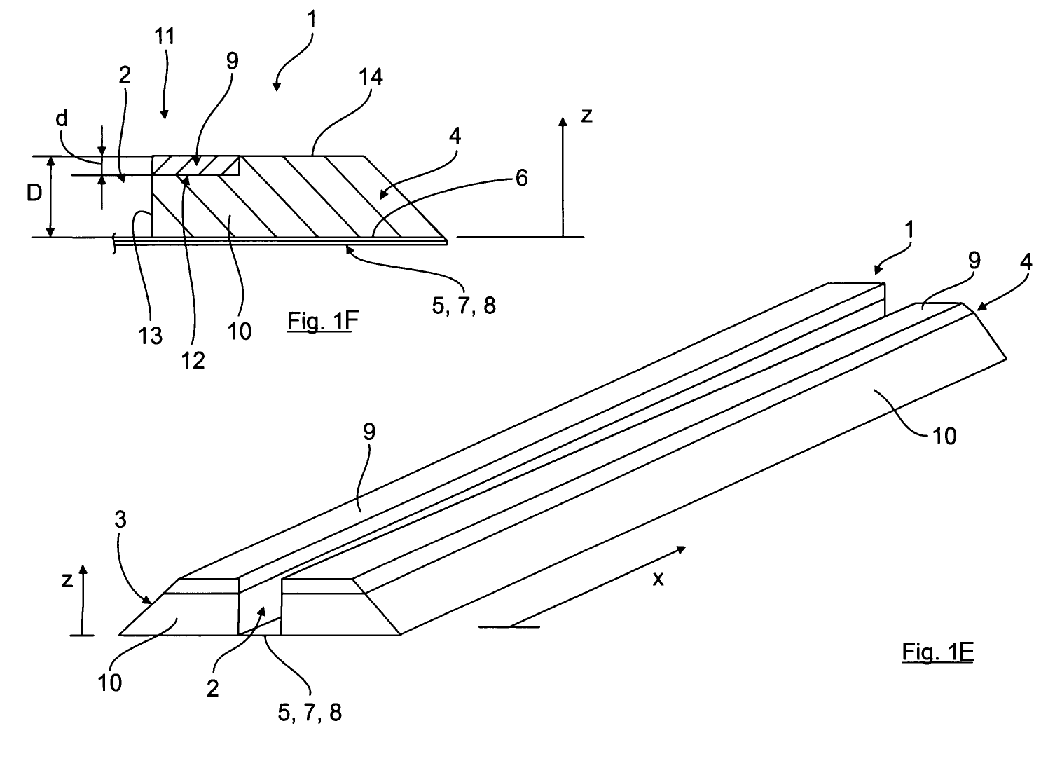

FIG. 1a schematically shows a cross-section through an exemplary die strip according to the invention that configures a counter-die, in the state of production prior to the use thereof in a punching or creasing tool, respectively;

FIG. 1b shows the die strip according to FIG. 1a at the beginning of a punching or creasing process, respectively;

FIG. 1c shows a cross-section corresponding to that of FIG. 1b in an impingement of the punched or creased product, respectively, by pressure by way of a punching or creasing tool, respectively;

FIG. 1d shows a cross-section through the die strip corresponding to that of FIGS. 1b and 1c, at the end of the punching or creasing process, respectively, when the processed punched or creased product, respectively, is removed;

FIG. 1e schematically shows a perspective illustration of the die strip of FIGS. 1a to 1d, from which it can be seen that the upper layer of the material strip that is formed from an elastically resilient material extends across the entire length of the die strip;

FIG. 1f shows an embodiment of a die strip that is an alternative to that of FIGS. 1a to 1e, in which only a peripheral edge region of the upper side of the material strip that is directly adjacent to a groove channel is configured from an elastically resilient material;

FIG. 1g shows embodiments which are an alternative to that of FIG. 1a;

FIG. 1h shows further embodiments that are an alternative to that of FIG. 1a;

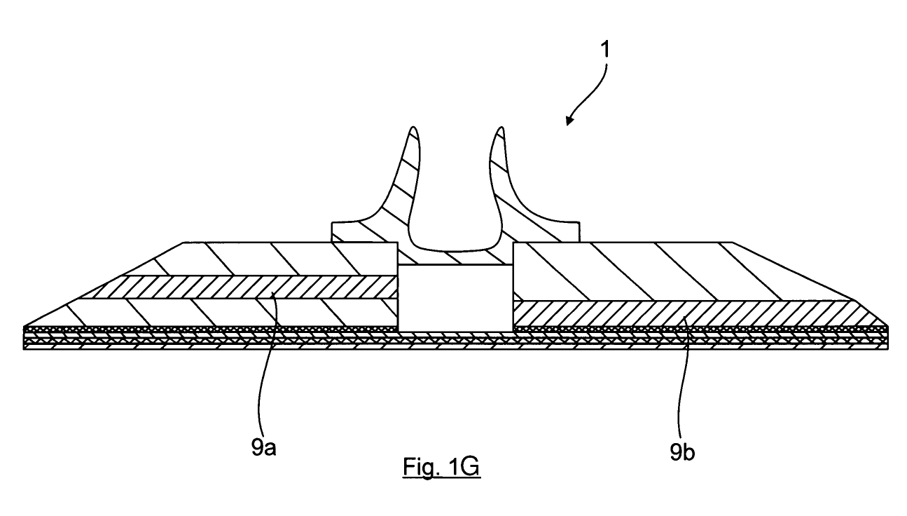

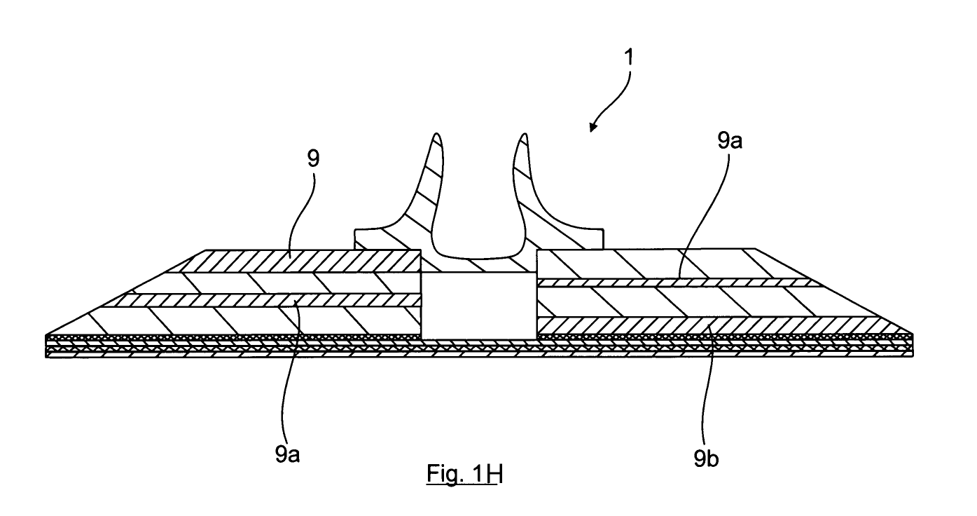

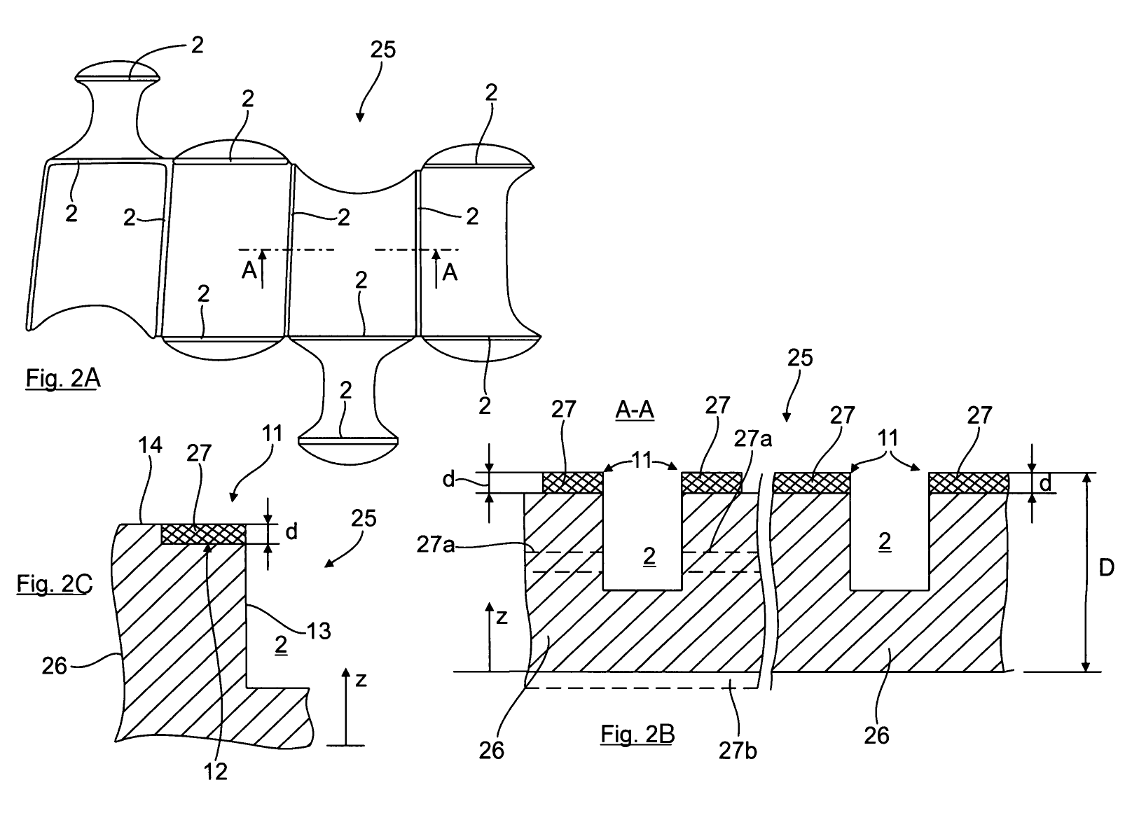

FIG. 2a schematically shows a plan view of an exemplary creasing matrix;

FIG. 2b schematically shows a heavily enlarged sectional illustration along the line A-A of FIG. 2a, wherein a variant of embodiment in which the upper side of the creasing matrix that configures the contact and/or bearing face for the material be processed is configured by a raised layer from an elastically resilient material only in a peripheral edge region that is directly adjacent to the groove channel is shown in the left image half of said FIG. 2b, while it is illustrated in the right image half of FIG. 2b that the upper side of the creasing matrix is entirely or at least in a manner covering a large area, respectively, formed by a layer from an elastically resilient material;

FIG. 2c schematically shows an embodiment that is an alternative in particular to the left image half of FIG. 2b, in which the layer from the elastically resilient material that is provided only in regions is embedded and received so as to be substantially flush with the surface in a peripheral edge recess of the upper side of the creasing matrix that is directly adjacent to the groove channel;

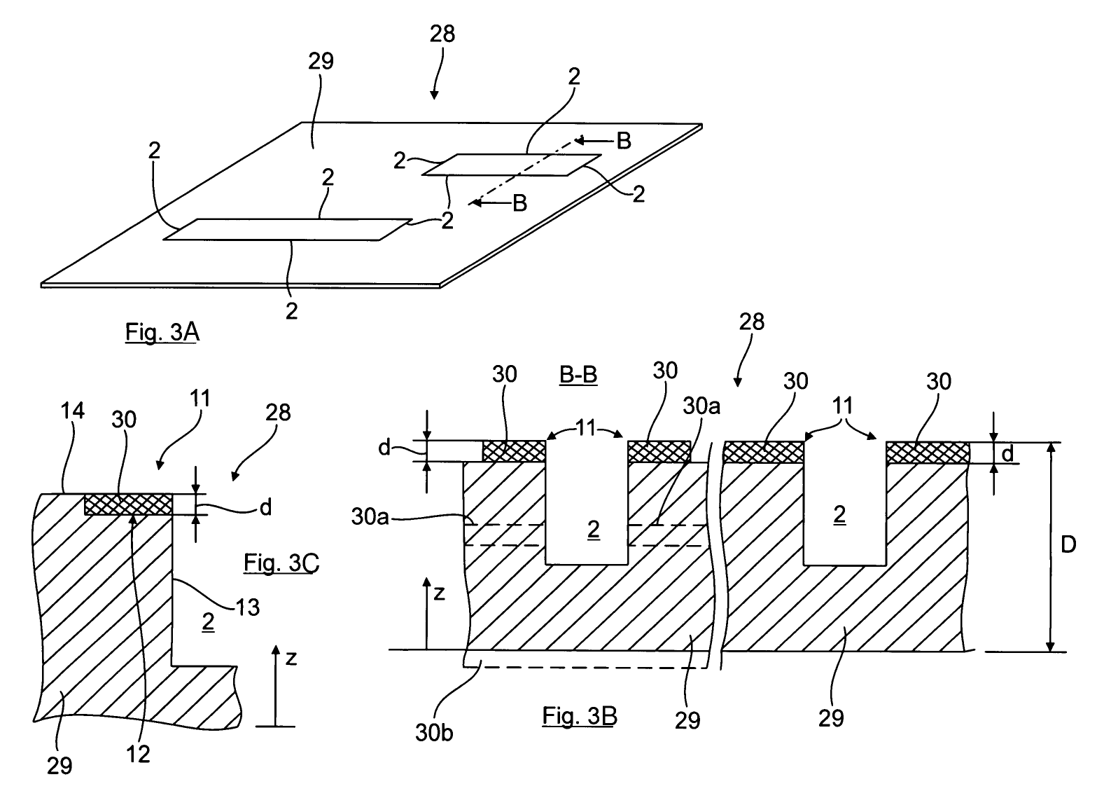

FIG. 3a schematically shows a perspective illustration of a further embodiment according to the invention of a counter-die which here is configured as a punch-creasing plate;

FIG. 3b schematically shows a heavily enlarged sectional illustration along the line B-B of FIG. 3a, wherein a variant of embodiment in which the upper side of the punch-creasing plate that configures the contact and/or bearing face for the material to be processed is configured by a raised layer from an elastically resilient material only in a peripheral edge region that is directly adjacent to the groove channel is shown in the left image half of said FIG. 3b, while it is illustrated in the right image half of FIG. 3b that the upper side of the punch-creasing plate is entirely or at least in a manner covering a large area, respectively, formed by a layer from an elastically resilient material;

FIG. 3c schematically shows an embodiment that is an alternative in particular to the left image half of FIG. 3b, in which the layer from the elastically resilient material that is provided only in regions is embedded and received so as to be substantially flush with the surface in a peripheral edge recess of the upper side of the punch-creasing plate that is directly adjacent to the groove channel.

A cross-section through a first embodiment according to the invention of a counter-die that is configured as a die strip 1 is shown schematically and in an exemplary manner in FIG. 1a, said die strip 1, in relation to the cross-section, here in an exemplary manner in the central region having a groove channel 2 which is formed by two mutually spaced-apart raised material strips 3, 4 which in an exemplary manner run so as to be mutually parallel and configure groove channel walls.

The material strips 3, 4 which here in an exemplary manner in terms of their external shape are configured so as to be identical or the same, respectively, are applied as raised profiles to a carrier layer 5, for example a carrier film. Securing the material strips 3, 4 to the carrier layer in principle can be performed in any suitable manner. The securing of the material strips 3, 4 to the carrier layer 5 by means of an adhesive layer 6 which can be formed, for example, by an adhesive agent or the like, is shown here in an exemplary manner.

The carrier layer on the lower side thereof that faces away from the material strips 3, 4 is provided with a further adhesive layer 7, for example, which in turn can likewise be configured by an adhesive agent or the like. This adhesive layer 7 is moreover preferably provided or covered, for example by a protective cover 8 that covers said adhesive layer 7 and is releasable, for example by tearing off. This protective cover 8 can be formed from paper, for example, or else can also be formed by a film or the like.

Moreover, as can furthermore be derived from the schematic and exemplary cross-sectional illustration of FIG. 1a, the two groove channel walls or material strips 3, 4, respectively, that configure the groove channel 2 here are configured in two layers, having an upper layer 9 from an material that at a defined impingement with pressure is elastic and configures the upper side as an elastic part-region, and having a lower layer 10 from a material that at the same impingement with pressure is dimensionally stable and non-compressible, but at least from a material that in relation to the elastic material of the upper layer 9 is more dimensionally stable and/or harder.

The upper layer 9 from the elastic material is preferably formed by an elastomer, for example from polyurethane (PU). Thermoplastic polyurethane (TPU) is particularly preferable.

The material of the lower layer 10 is, for example, a metal, fiber board, or a plastics material. A thermosetting plastics material, for example polyester, or a thermoplastic material, for example polypropylene in, can be used as the plastics material for the lower layer 10, in order to mention only one example. The plastics materials used can moreover also be fiber-reinforced, for example be reinforced with glass fibers or carbon fibers, in order to mention only one example. Other hard materials can also be used at any time.

The elastic material of the upper layer 9 here is preferably selected such that said elastic material has an elasticity modulus of 10 to 500 MPa, preferably of 20 to 400 MPa, most preferably of 20 to 250 MPa.

The lower layer 10 of the material strips 3, 4 preferably has an elasticity modulus of 600 to 100,000 MPa, particularly preferably of 700 to 40,000 MPa.

The upper layer 9 of the material strips 3, 4 preferably has here a layer thickness d of 0.01 to 1.90 mm, preferably of 0.05 to 0.30 mm.

The overall layer thickness D of the upper layer 9 and the lower layer 10 of the material strips 3, 4 (that is to say without the adhesive layers 6, 7, without the carrier layer 5, and without the protective cover 8) is preferably 0.1 to 2.0 mm, preferably 0.3 to 1.7 mm.

As can be furthermore seen from FIG. 1e which shows only a perspective schematic view of the die strip 1 that in FIG. 1a is shown in the cross-section, the upper layer 9 when viewed in the longitudinal extent direction of the die strip 1 here extends across the entire material strip length.

By contrast to the illustration in FIG. 1e, the upper layer 9 according to a further design embodiment (not shown here) that is configured from an elastically resilient material could extend only across a part-region of the longitudinal extent direction x of the die strip, or be provided only in portions in relation to the longitudinal extent direction x of the die strip, respectively, for example in such a manner that the lower layer 10 is exposed between individual upper-layer regions that are configured from an elastically resilient material. An arrangement of this type in part-regions or regions, respectively, or portions, is in principle of course also possible in conjunction with an embodiment such as is illustrated in FIGS. 1a to 1d, and in FIG. 1f.

As can be very well seen from FIG. 1a which shows a cross section, the upper layer 9 (like the lower layer 10) when viewed in the transverse direction y here extends across the entire width of the respective material strip 3, 4 and thus configures an elastic layer that runs in the transverse direction y and is horizontally aligned.

Alternatively thereto, the elastically resilient material could also configure only a part-region of the upper side of the material strips 3, 4, as this is illustrated schematically and only in an exemplary manner in FIG. 1f. The upper side there of the material strip 4 that is illustrated here in an exemplary manner in a peripheral edge region 11 that is directly adjacent to the groove channel 2 has a recess 12 which here in only an exemplary manner is in the manner of a pocket and/or a step, the elastically resilient material being inserted into said recess 12 so as to be flush with the surfaces of the wall regions 13 and 14 that are adjacent thereto. The upper layer 9 that is configured from an elastically resilient material, for example an elastomeric material, here thus configures only a part-region of the upper side of the material strip 4. It is to be understood that the opposite material strip 3 (not shown here) can be configured either in analogous manner, or else alternatively like the material strip described previously, in which the entire upper layer is formed from an elastically resilient material.

According to a further alternative embodiment, instead of the embodiment having the elastic upper layer 9, illustrated in FIG. 1a, or additionally thereto, as is illustrated schematically and only in an exemplary manner in FIGS. 1g and 1h an elastic intermediate layer and/or an elastic lower layer could also be provided. An embodiment in which only one elastic intermediate layer 9a which here in an exemplary manner is continuous in the transverse direction y and is horizontally aligned is provided as an elastic layer is schematically illustrated in the left image half of FIG. 1g. By contrast, an embodiment in which only one elastic lower layer 9b which here in an exemplary manner is continuous in the transverse direction y and is horizontally aligned is provided as a substantially external elastic layer of the material strip 3 or 4, respectively, is schematically illustrated in the right image half of FIG. 1g. It is to be understood that the opposite material strips 3, 4 in the case of a specific embodiment here can of course be constructed so as to be substantially the same or identical, respectively, at least in terms of the composition and the configuration of the layer.

As is illustrated in FIG. 1h, combinations are also possible, for example in such a manner as shown in the left image half of FIG. 1h, so that apart from an elastic upper layer 9 corresponding to the design embodiment as per FIG. 1a, an elastic intermediate layer 9a corresponding to the left image half of FIG. 1g is also additionally provided. Or in that, as is illustrated in the right image half of FIG. 1h, in addition to the elastic intermediate layer 9a corresponding to the embodiment of the left image half of FIG. 1g, an elastic lower layer 9b corresponding to the embodiment shown in the right image half of FIG. 1h is furthermore provided. It is to be understood here too that the opposite material strips 3, 4 in the case of a specific embodiment can of course be constructed so as to be preferably substantially the same or identical, respectively, at least in terms of the composition and the configuration of the layer.

Of course, even further combinations are possible, for example a combination of an elastic upper layer 9 with an elastic lower layer 9b (not shown here) or a combination of an elastic upper layer 9 with an elastic intermediate layer 9a and an elastic lower layer 9b (not shown here).

As has already been explained, in the context of the examples of different embodiments shown in FIGS. 1g and 1h it is preferable that the two material strips 3, 4 that are assigned to a groove channel 2 and configure the latter are constructed so as to be substantially the same or identical, respectively, even when there is of course in principle also the possibility for said material strips 3, 4 to be of dissimilar construction.

Otherwise, the construction of FIGS. 1g and 1h is identical to that of FIG. 1a such that reference can be made to the explanations pertaining thereto and only those reference signs which relate to the elastic layers are indicated in FIGS. 1g and 1h.

As can furthermore be derived from FIG. 1a a pilot strip 15, which in a manner known per se serves for being fitted onto a crease line or the like in order for the die strip upon release of the protective cover 8 to be able to be secured and positioned accurately on a punching plate, for example, in the activation of a tool, can be releasably mounted in the groove channel 2 of the die strip 1 prior to said pilot strip 15 being fitted.

FIGS. 1b to 1d now show the die strip 1 according to the invention according to an embodiment of FIG. 1a in operation during a punching or creasing procedure, respectively, in which—presently only in a manner representative of all suitable punched or creased products, respectively—a printed sheet 16 from paper, cardboard, corrugated cardboard, or the like materials, as the punched or creased product, respectively, is incorporated in a punching or creasing tool, respectively, (not illustrated in more detail here) in such a manner (arrow 17) that the printed sheet 16 bears in a planar manner on the elastic upper layer 9 of the material strips 3, 4 of the die strip 1 that configures the contact and/or bearing face for the printed sheet 16. It is to be understood that a multiplicity of die strips of this type can be present and that the fundamental operating principle is shown in a schematic and only exemplary manner here in conjunction with FIGS. 1b to 1d.

As is indicated in FIG. 1b by the pressure arrows 18, a force acting in the direction toward the groove channel 2, by way of which force the printed sheet 16 is deformed or creased, respectively, in a printed-sheet wall region 20 facing the groove channel 2, as is illustrated in FIG. 1c, is exerted on the printed sheet 16 by way of a tool-side creasing tool 19 which is only schematically illustrated here and can be formed by a crease line, for example, in the punching or creasing procedure.

As is furthermore illustrated in FIG. 1c, the upper layer 9 that is produced from an elastically resilient material in this punching or creasing procedure respectively, at least in the peripheral edge region 11 that is directly adjacent to the groove channel is compressed by the force acting on the material strips 3, 4 from the side of the printed sheet, as is illustrated in an exemplary and schematic manner by the arrows 21 in FIG. 1c, while the remaining region of the material strips 3, 4 which is produced from the comparatively more dimensionally stable and/or harder material in this impingement with pressure maintains its shape without any modification, thus remains dimensionally stable and non-compressed, thus imparting the required stability to the respective material strip 3, 4.

After the punching or creasing procedure, respectively, that is to say when the creasing tool 19 is again lifted away from the die strip 1 in a manner corresponding to the arrows 22 and the creased printed sheet 16 is rejected or removed, respectively, from the tool in a manner corresponding to the arrow 23, the upper layer 9 springs back to the initial position as is schematically illustrated by the arrows 24 in FIG. 1d. The production process can recommence then.

The upper layer 9 springing back herein supports the rejection process because catching of the printed sheet 16 is avoided, for example. Moreover, a longer production and service life is achieved by the upper layer 9 having elastic properties.

It is to be understood that the functional principle that is shown here only in a schematic and fundamental manner by means of the particularly preferred embodiment of FIG. 1a of course applies in analogous manner to all other exemplary embodiments that are comprised by the scope of protection, in particular for the exemplary embodiments shown in FIGS. 1fd, 1g, and 1h.

It is furthermore to be understood that the printed sheet 16 during the punching or creasing procedure, respectively, is retained or held in position, respectively by means of a suitable holding installation which is not illustrated here.

A further alternative exemplary embodiment of a counter-die that is configured as a creasing matrix 25 is now shown in FIG. 2a. This creasing matrix which is produced, for example, from a hard paper, for example Pertinax®, but fundamentally also from any other suitable material (fundamentally also entirely from an elastic material) here has a plurality of groove channels 2 which are shown here in only an exemplary manner. These groove channels 2 are incorporated, for example by milling, as depressions into the surface of a matrix main body 26 such that the groove channel walls that delimit the respective groove channel 2 are configured by the matrix main body 26.

As is illustrated in an only schematic and exemplary manner in FIG. 2b which shows a sectional illustration of exaggerated size along the line A-A of FIG. 2a, the upper side of the creasing matrix 25 here in a large area or optionally even entirely (right image half of FIG. 2b), respectively, or alternatively only in regions (left image half of FIG. 2b) can be configured by an elastic material such that the upper side of the creasing matrix that configures the contact and/or bearing face for a printed sheet 16 at least in regions is formed by this elastically resilient material. It also applies here again in principle, in a manner analogous to that of the variant of embodiment according to FIGS. 1a to 1h, that the region of the upper side that configures the elastic part-region is configured from a material that in a defined impingement with pressure is elastic, while the material of the matrix main body 26 is formed from a material that in the same impingement with pressure is dimensionally stable and non-compressible, but at least from an material that in relation to the elastic material of the upper side is more dimensionally stable and/or harder.

The elastically resilient material here, in a manner analogous to that of the embodiment according to FIG. 1 can be formed by an elastomeric layer that is applied to the matrix main body 26 and which is fixedly connected to the matrix main body 26. The layer 27 from the elastically resilient material, which is formed from an elastically resilient material, for example PU or TPU, respectively, herein can in principle be applied for example to the matrix main body 26 prior to the groove channels 22 being incorporated therein, or else be applied subsequently. An integral configuration of the elastic layer is possible here in principle.

As has already been indicated above, it is illustrated in the left image half of FIG. 2b that the layer from the elastically resilient material can in principle also be configured only in a peripheral edge region 11 that is directly adjacent to the groove channel 2.

The layer 27 as is illustrated in FIG. 2c, in a manner analogous to the design embodiment according to FIG. 1f, can however again also be inserted in a recess 12 in the peripheral edge so as to be flush with the surface. In terms of this design embodiment according to FIG. 2c reference is otherwise made to the analogous explanations pertaining to FIG. 1f.

Even while this is not illustrated explicitly in FIGS. 2a to 2c, it is to be understood that the layer 27 from the elastically resilient material of course extends at least in regions or at least in portions, preferably entirely, along the groove channels 2 of the creasing matrix 25.

The layer 27 from the elastically resilient material preferably has an elasticity modulus of 10 to 500 mPa, preferably of 20 to 400 MPa, most preferably of 20 to 250 MPa. The elasticity modulus of the matrix main body 26 is preferably 600 to 100,000 MPa, particularly preferably 1000 to 50,000 MPa.

Furthermore, the layer thickness d of the region that is formed by the elastically resilient material can be 0.01 to 1.90 mm, preferably 0.05 to 0.30 mm. the overall layer thickness D of the matrix main body is preferably 0.1 to 2.0 mm, preferably 0.3 to 1.7 mm.

A further alternative exemplary embodiment of a counter-die that is configured as a punch-creasing plate 28 is shown in FIG. 3a. This punch-creasing plate 28 that is produced from steel, for example, but in principle also from any other suitable material (in principle also entirely from an elastic material) here has a plurality of groove channels 2 which are shown only in an exemplary manner. These groove channels 2 are incorporated, for example by milling, as depressions in the surface of a punching plate as the punch-creasing plate main body 29 such that the groove channel walls that delimit the respective groove channel 2 are configured by the punch-creasing plate main body 29.

As is illustrated only schematically and in an exemplary manner in FIG. 3b which shows a sectional illustration, illustrated in an exaggerated size, along the line B-B of FIG. 3a, the upper side of the punch-creasing plate 28 here in a large area or optionally even entirely (right image half of FIG. 3b), respectively, or alternatively only in regions (left image half of FIG. 3b) can be configured by an elastic material such that the upper side of the punch-creasing plate that configures the contact and/or bearing face for a printed sheet 16 at least in regions is formed by this elastically resilient material. It also applies here again in principle, in a manner analogous to that of the variant of embodiment according to FIGS. 1a to 1h, that the region of the upper side that configures the elastic part-region is configured from a material that in a defined impingement with pressure is elastic, while the material of the punch-creasing plate main body 29 is formed from a material that in the same impingement with pressure is dimensionally stable and non-compressible, but at least from a material that in relation to the elastic material of the upper side is more dimensionally stable and/or harder.

The elastically resilient material here, in a manner analogous to that of the embodiment according to FIG. 1 can be formed by an elastomeric layer that is applied to the punch-creasing plate main body 29 and which is fixedly connected to punch-creasing plate main body 29. The layer 30 from the elastically resilient material, which is formed from an elastically resilient material, for example PU or TPU, respectively, herein can for example in principle be applied to the punch-creasing plate main body 29 prior to the groove channels 22 being incorporated therein, or else be applied subsequently. An integral configuration of the elastic layer is possible here in principle.

As has already been indicated above, it is illustrated in the left image half of FIG. 3b that the layer from the elastically resilient material in principle can also be configured only in a peripheral edge region 11 that is directly adjacent to the groove channel 2.

The layer 30 as is illustrated in FIG. 3c, in a manner analogous to the design embodiment according to FIG. 1f, can however again also be inserted in a recess 12 in the peripheral edge so as to be flush with the surface. In terms of this design embodiment according to FIG. 3c reference is otherwise made to the analogous explanations pertaining to FIG. 1f.

Even while this is not illustrated explicitly in FIGS. 3a to 3c, it is to be understood that the layer 30 from the elastically resilient material of course extends at least in regions or at least in portions, preferably entirely, along the groove channels 2 of the creasing matrix 25.

The layer 30 from the elastically resilient material preferably has an elasticity modulus of 10 to 500 MPa, preferably of 20 to 400 MPa, most preferably of 20 to 250 MPa. The elasticity modulus of the punch-creasing plate main body is preferably 1000 to 240,000 MPa, particularly preferably 2000 to 220,000 MPa.

Furthermore, the layer thickness d of the region that is formed by the elastically resilient material can be 0.01 to 1.90 mm, preferably 0.05 to 0.30 mm. the overall layer thickness D of the punch-creasing plate main body is preferably 0.1 to 2.0 mm, preferably 0.3 to 1.7 mm.

The functional mode of the creasing matrix 25, or of the punch-creasing plate 28, respectively, is exactly as has been described in the context of the die strip 1 in FIGS. 1b to 1d, such that in terms thereof reference is made to the explanations in the context of the latter. This means that here again the layer 27 in the case of the creasing matrix 25 as well as the layer 30 in the case of the punch-creasing plate 28 in an impingement with pressure during the punching or creasing procedure is compressed and subsequently after the end of the respective punching or creasing procedure, respectively, springs back to the initial position such that the upper sides of the groove channel walls of the respective groove channel 2, proceeding from an initial position are displaced in a downward manner at least partially in the vertical axis and/or processing direction z, wherein the upper side after the impingement with pressure, by virtue of the elastic material springing back to the uncompressed state in a self-acting manner, returns back to the initial position.

Here too, as is plotted in the exemplary manner with dashed lines in each case only in the left image half in FIG. 2b and FIG. 3b, alternatively or additionally to the layer 27 or 30, respectively, at least one elastic intermediate layer 27a or 30a, respectively, and/or optionally even an elastic lower layer 27b or 30b, respectively, can be provided. It is in principle advisable or optionally even required, respectively, in conjunction with an elastic intermediate layer 27a or 30a, respectively, in the case of the presently planar main bodies that said intermediate layer 27a or 30a, respectively, extends across the entire or almost the entire area, respectively, of the creasing matrix or of the punch-creasing plate, respectively, and thus configures a substantially continuous intermediate layer. Moreover, the intermediate layer, or at least one of the intermediate layers, respectively, in this instance is to be preferably configured in a region that neighbors the groove channel in order for functional reliability to be guaranteed.

As is demonstrated by the exemplary embodiments of FIGS. 1 to 3 shown here, it is particularly advantageous for the upper sides which configure a contact and/or bearing face for the punched and/or creased product to be processed, for example a printed sheet, when viewed in the direction of the vertical axis z to be configured so as to be substantially horizontal and/or flat so that the punched and/or creased products to be processed can bear thereon or against in a planar connection. Alternatively or additionally thereto, it is particularly advantageous when at least in relation to a groove channel the upper sides that lie on opposite sides of the groove channel when viewed in the direction of the vertical axis z are at the same height or are at least approximately at the same height, respectively.

The explanations made in the preceding paragraph apply explicitly in very general terms to all counter-dies according to the invention and are not to be considered to be limited only to the exemplary embodiments shown.

1-20. (canceled)

21. A counter-die for punching and/or creasing product, the counter-die comprising:
two mutually spaced apart groove-channel walls defining a groove channel therebetween, each of said groove-channel walls having an upper side forming a contact and/or bearing face for the product to be processed;
elastic material disposed to form a displaceable and elastically resilient upper side of at least a portion of at least one of said groove-channel walls of said groove channel.

22. The counter-die according to claim 21, wherein said elastic material, upon impingement of the counter-die by pressure, is at least partially compressible such that an upper side of at least one of said groove-channel walls of said groove channel, proceeding from an initial position, is displaceable in a downward manner in a processing direction, and wherein the upper side, after the impingement with pressure, springs back to an uncompressed state in a self-acting manner to return to the initial position.

23. The counter-die according to claim 21, wherein the counter-die is configured from said elastic material only in regions and has at least one elastic part-region formed from said elastic material.

24. The counter-die according to claim 23, which comprises at least one stable part-region adjoining said at least one elastic part-region and formed of a material that is more dimensionally stable and/or harder than a material of said elastic part-region.

25. The counter-die according to claim 24, wherein said stable part-region that adjoins said at least one elastic part-region is configured of a material that in an impingement with pressure in a compressive force range in which said at least one elastic part-region is compressible is dimensionally stable and non-compressible.

26. The counter-die according to claim 23, wherein said at least one elastic part-region defines an external layer of the counter-die that runs in a transverse direction and/or is horizontally aligned, and/or said at least one elastic part-region defines an intermediate layer of the counter-die that runs in the transverse direction and/or is horizontally aligned.

27. The counter-die according to claim 26, wherein said elastic part-region forming the external layer adjoins said stable part-region and forms an upper side and/or lower side in relation to a processing direction.

28. The counter-die according to claim 26, wherein said elastic part-region forming the intermediate layer is adjoined on both sides, in relation to the vertical axis and/or processing direction, by a respective layer of the stable part-region, or said elastic part-region forming the intermediate layer is adjoined on one side by a stable part-region and on the other side by a carrier and/or adhesive and/or cover layer.

29. The counter-die according to claim 23, wherein said elastic part-region is configured in at least one part-region that is directly adjacent to the groove channel.

30. The counter-die according to claim 20 being a die strip having at least one groove channel, wherein said at least one groove channel is formed by two mutually spaced-apart, raised material strips that extend parallel to one another and form said groove channel walls, and wherein at least one material strip forming a groove channel wall of a groove channel has an upper side formed of elastic material that is elastically resilient and is displaceable, at least in a part-region of the material strip that is assigned to the groove channel.

31. The counter-die according to claim 30, wherein at least one of said material strips forming the groove channel walls is formed of multiple layers, wherein said at least one material strip is only in regions configured from an elastic material and has at least one elastic part-region configured from the elastic material that forms at least one elastic layer of the material strip and extends in a transverse direction and/or is horizontally aligned, said elastic layer of the material strip being adjoined by a residual wall region of the material strip that forms a stable part-region and which, in relation to the at least one elastic layer, is configured from a more dimensionally stable and/or harder material.

32. The counter-die according to claim 31, wherein one or more of the following is true:
said at least one elastic layer is an elastic upper layer that at least in regions forms the upper side;
said at least one elastic layer is at least one intermediate layer that at least in regions forms an intermediate tier;
said at least one elastic layer is an elastic lower layer of the material strip that at least in regions configures the lower side.

33. The counter-die according to claim 31, wherein said material strip forming one or both walls of the groove channel is formed of a plurality of layers, wherein said elastic layer is formed by an elastic upper layer that at least in regions configures the upper side and is adjoined, downwardly and distally from said upper layer, by at least one lower layer of the material strip that forms the stable part-region, said at least one lower layer being formed of a material which, in relation to the elastic upper layer, is more dimensionally stable and/or harder and which, upon impingement with pressure in a compressive force range in which the elastic upper layer is compressible, is dimensionally stable and non-compressible.

34. The counter-die according to claim 31, wherein said at least one elastic part-region, when viewed in the longitudinal extent direction of the die-strip, extends at least partially along a longitudinal extent of a material strip length of the dies-strip.

35. The counter-die according to claim 21 being a creasing matrix or a punch-creasing plate having at least one groove channel that is machined into a surface of a matrix main body or a punch-creasing plate main body, wherein groove channel walls that delimit said at least one groove channel are defined by said matrix main body or said punch-creasing plate main body, and wherein said elastic material is disposed to define an elastically resilient upper side that is displaceable at least in regions of at least one groove channel wall of said at least one groove channel at least in regions.

36. The counter-die according to claim 35, wherein said matrix main body or said punch-creasing plate main body is configured from an elastic material only in regions, and at least one elastic part-region is formed by said elastic material and at least in part is formed by at least one elastic layer of said matrix main body or said punch-creasing plate main body that extends in a transverse direction and/or is horizontally aligned, said elastic layer being adjoined by a residual wall region of said matrix main body or said punch-creasing plate main body that configures a stable part-region which in relation to said at least one elastic layer is formed of a more dimensionally stable and/or harder material, which, upon an impingement with pressure in a compressive force range in which the at least one elastic layer is compressible, is dimensionally stable and non-compressible.

37. The counter-die according to claim 36, wherein one or more of the following is true:
said at least one elastic layer is an elastic upper layer that at least in regions forms an upper side;
said at least one elastic layer is at least one elastic intermediate layer that at least in regions configures an intermediate tier;
said at least one elastic layer is an elastic lower layer of the matrix main body or of the punch-creasing plate main body that at least in regions form a lower side.

38. The counter-die according to claim 21, wherein said elastic material has a modulus of elasticity of 10 to 500 MPa.

39. The counter die according to claim 21, which comprises a more stable part-region adjoining said at least one elastic part-region, said more stable part-region having a material that, in relation to said elastic part-region, is more dimensionally stable and/or harder, said more stable part-region having a modulus of elasticity of 600 to 250,000 MPa.

40. A method for creasing paper, cardboard, or corrugated cardboard material, the method comprising:
providing a punching and/or creasing tool with at least one counter-die, the counter-die having at least one groove channel between two mutually spaced-apart groove channel walls forming the groove channel, and wherein the groove channel walls have an upper side with a contact and/or bearing face for the material to be processed;
wherein the counter-die at least in regions is configured from an elastic material, so that the counter-die is at least partly elastic such that, upon impingement with pressure from a tool that carries out the creasing operation is at least partially compressed;
subjecting the counter-die to pressure with the tool to at least partially compress the counter-die in such a manner that an upper side of at least one of the groove channel walls of a groove channel, proceeding from an initial position, is displaced in a downward direction defining a processing direction, and wherein the upper side after the impingement with pressure, by virtue of the elastic material springs back to the uncompressed state in a self-acting manner, returning to the initial position.
